(19) United States
(12) Patent Application Publication
(10) Pub. No.: US 2008/0217238 A1
(43) Pub. Date: Sep. 11, 2008

(54) Spiral filter that receives water from its top, bottom and side

(76) Inventor: Thomas E. Pank, Walkersville, MD (US)

Correspondence Address: WILLIAM D. HALL, 10850 STANMORE DR, POTOMAC, MD, 20854, US

(21) Appl. No.: 12/148,749

(22) Filed: Apr. 22, 2008

Related U.S. Application Data
(63) Continuation-in-part of application No. 11/030,939, filed on Jan. 7, 2005.
Application No. 11/030,939 is a continuation-in-part of application No. 11/522,150, filed on Sep. 16, 2006.
(60) Provisional application No. 60/925,949, filed on Apr. 24, 2007.

(51) Int. Cl. B01D 29/07

(52) U.S. Cl. 210/461; 210/487

(57) ABSTRACT

A spiral filter has four layers wound around a central perforated outlet pipe. An input layer which extends not only around the outer sidewall but also to the top side and the bottom side of the filter receives the water to be filtered from all of said sides and feeds the incoming water through two layers containing a filtering media. The water then passes to an output layer which feeds the perforated outlet pipe.

### RELATED CASES

I claim the benefit of my prior copending provisional application Ser. No. 60/925,949, filed Apr. 24, 2007. The present application is also a continuation-in-part of my prior copending application Ser. No. 11/030,939 filed Jan. 9, 2005 and Ser. No. 11/522,150 filed Sep. 16, 2006.

### BACKGROUND OF THE INVENTION

During construction of a project, the ground is disturbed and for a period of time left as exposed soil. When it rains, there is no grass or vegetative cover to prevent erosion of the exposed soil. A heavy rainfall can produce serious amounts of erosion of these soils and if not captured before this contaminated runoff enters a watershed, the streams and lakes downstream will become heavily contaminated with these sediments. This leads to serious degradation of the watersheds downstream. To prevent this, regulations require that measures are installed on the site and that the water be treated prior to downstream discharge to prevent release of this sediment laden water.

Over the years various apparatus and methods have been used to clean this water and many have shortcomings. To insure that the majority of the contaminants are removed, the water in a pond or container is slowly released through a filter means or other outlet control as cleaned water. One problem with filtration is that the finer, or the more restrictive the filter media, the better it works, but the quicker it becomes occluded. To overcome this, a greater surface area of filter media can be used, but that takes up space and very often is impractical and costly.

Currently sediment control and storm water ponds have used a single layer of filter fabric around a pipe to filter the water as it flows out of the pond. This cleaning method has a huge limitation. Moreover, with heavy sediment loads such systems become clogged and stop up very quickly.

### SUMMARY OF THE INVENTION

The present invention is a means and apparatus for solving the foregoing problem by using a spiral wound cartridge comprising four or more layers wound such that there is a large amount of filter surface area achieved in a relatively small circumference.

The four layers include an inlet layer that will receive dirty water from the top side, the bottom side and the sidewall of the filter.

The preferred form of the invention comprises a spiral wound cartridge configured with four layers, two processing layers (one of which is an inlet layer and the second is the outlet layer) and two filtration layers. These four layers are configured in a spiral, such that the water is able to freely flow into the inlet layer, which is open to the pond or container, as aforesaid. The water also flows through an output layer which is connected to the center tube where it is piped outside of the pond or container as filtered water.

The spiral layers are configured so that the water cannot go from the inlet layer to the outlet layer without first passing through the filter layer. In the preferred form of the invention, the inlet layer has a filter layer on each side of it and the outlet layer does as well. This optimizes uses of the drainage media layers and allows for more surface area of the filtering layers in a smaller spiral.

The invention also incorporates the use of a standpipe. The filter fits on the standpipe and can be easily replaced during maintenance.

In the preferred form of the invention, the media layer is simply a layer of filter cloth that is inexpensive yet effective. The preferred form of the invention has a plastic media that allows water to flow to the drainage layer.

The water can enter the inlet layer from the side as well as the top or bottom of the spiral. The outlet layer must have a layer of fabric between it and the water in the container or pond, however it can be sealed at any point where there is no fabric or there is concern of breakage or damage such as at the top or bottom of the spiral.

This filter can be configured to receive dirty water from outside of the spiral and clean the water as it flows inside the spiral. The filter could also, in another form, receive dirty water at the center of the spiral and clean the water as it flows outward.

### BRIEF DESCRIPTION OF THE DRAWINGS

FIG. 1 is a plan view of the filtering element of the overall system.

FIG. 2 is a cross sectional view along lines 2-2 of FIG. 1.

FIG. 3 shows how the filter may be installed in a typical pond.

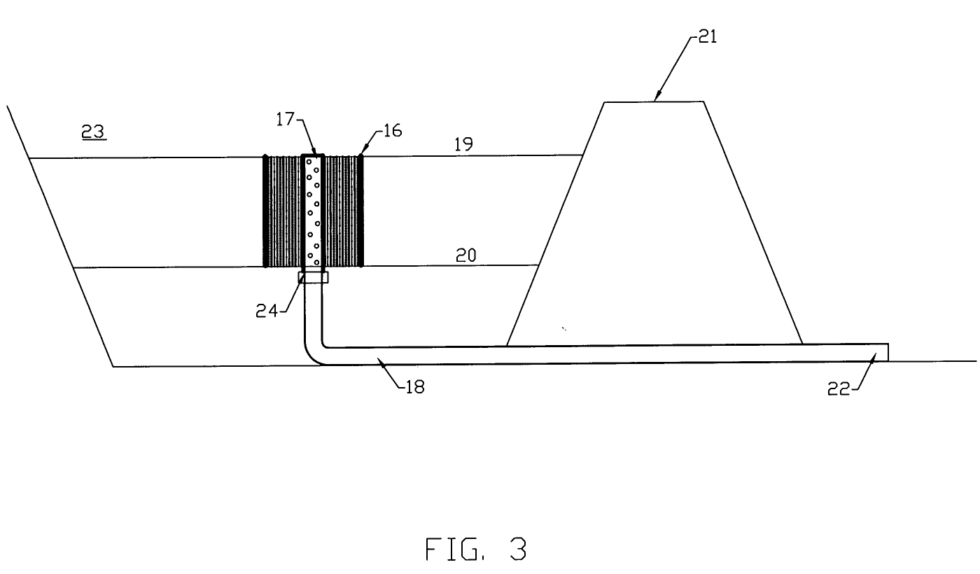

FIGS. 4 and 5 are cross sectional views of two modified forms that the input layer 10 and the drain layer 12 may take.

### DETAILED DESCRIPTION OF THE PREFERRED FORM OF THE INVENTION

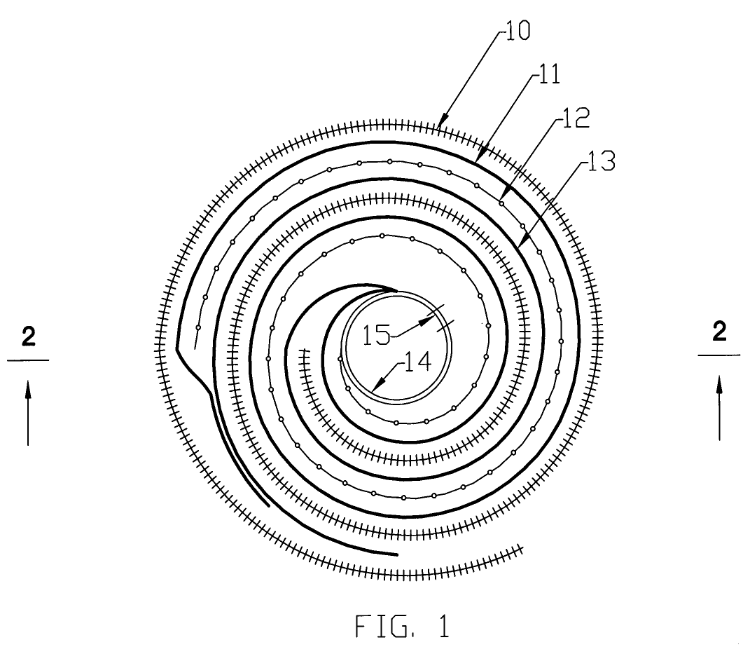

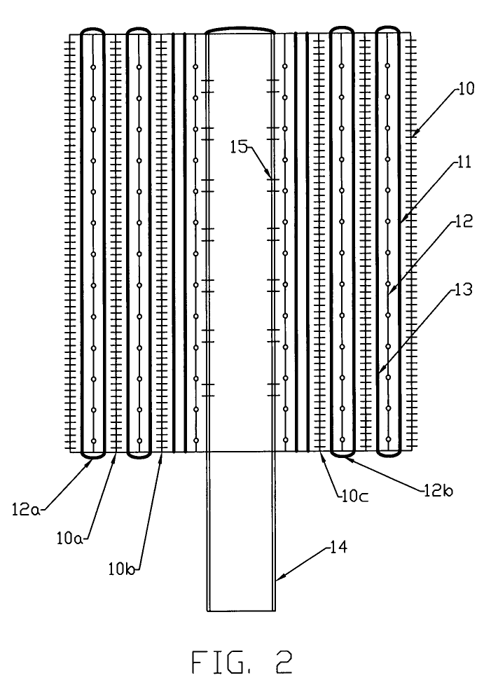

The preferred embodiment of the invention is shown in FIGS. 1 and 2. The filter is comprised of four layers 10, 11, 12, and 13 which are all wrapped around a central outlet conduit 14. The inlet layer 10 is in contact with not only the outside water but also with the filtration layers 11 and 13. The inlet layer 10 is open to the outside of the spiral so that water can flow into it and ultimately enter the inside of the spiral all the way to the center where the filtration layer 11 and 13 either overlap or are sealed to one another ending the flow of the water inside of the inlet layer 10.

The two filtration layers 11 and 13 are in contact with a face of the inlet layer 10 and are either effectively sealed by overlapping each other, or are sealed by other means, such that the only way for water to enter the outlet layer 12 is by passing the water through a filtration layer 11 or 13. By wrapping all of the layers in a spiral, the inlet drainage layer 10 is in contact with a filtration layer 11 or 13 on both sides of the layer 10, and the outlet layer 12 is in contact with a filtration layer 11 or 13 on both sides of the spiral as well.

In the preferred form of the invention, the outlet layer 12 is in communication with the central outlet conduit 14. The water then passes through perforations 15 located in the central outlet conduit 14, where the outlet layer 12 is in contact with the central outlet conduit 14.

In the preferred form of the invention the top of the central conduit 14 is sealed closed so that no unfiltered water can enter the outlet conduit. The central outlet conduit 14 is then in fluid communication with either a drain or other means for allowing the filtered water to be removed from the pond via pipe 18, 22.

The cartridge (the spiral) 16 is located on a standpipe 17 which is perforated such that water draining into the central outlet conduit 14 via holes 15 can enter the perforated standpipe 17 and flow out of the container or pond 23. There is preferably a seal that seals the central outlet conduit 14 to the pipe 18, 22 to prevent leakage. The perforated standpipe 14, 17 is, therefore, connected to an outlet conduit 18 which is in communication with the treated water outlet 22 of the container or pond 23. In the case of a pond, the container outlet conduit 18 passes through a weir 21 to get to the treated water outlet 22.

As contaminated water enters the container or pond 23, it must first fill the pond until it reaches a level 20 where water can begin entering the bottom of filter cartridge 16. Water may enter from the bottom or sides of the filter and ultimately when the water rises to level 19 it could enter the inlet layer 10 at the top side of the spiral. The water then flows into the inlet layer 10 and because initially there is no water in the outlet layer 12, it must flow through one or both of filtration layers 11 and 13. The filtered water that has passed through the filtration layers 11 or 13 is the only water that can enter the outlet layer 12.

The cartridge 16 is removable. In other words, the cartridge 16 can be lifted off of the standpipe 17 and the sealing means 24 is an o-ring. The cartridge can easily be removed and a fresh cartridge inserted very quickly and easily.

One very important feature of the invention is that the water in the pond can enter the spiral filter at the top side of the filter (FIG. 2) or at the bottom, or at the side walls. For example, when the filter of FIG. 2 is in a pond full of water the vertical outer sidewall of the filter is input layer 10. It completely surrounds the filter (see FIG. 1) and therefore will receive water from all directions.

The top and bottom edges 10a, 10b and 10c etc. of input layer 10 are exposed to water in the pond (assuming there is water at the level of these edges). Typical edges bear reference numbers 10a, 10b, and 10c.

However, layers 11, 12 and 13 will not receive water direct from the pond as their edges (FIG. 2), such as 12a and 12b, have all been sealed closed.

Thus, the foregoing can be summarized by saying that whenever the input layer 10 is exposed to water in the pond, whether it be at a side wall or at the top or bottom, the layer 10 is exposed so it will receive water from the pond.

However, whenever any layer, other than layer 10, is exposed to water in the pond, the exposed area is sealed to prevent entry of water directly from the pond.

Nothing said in the last few paragraphs modifies what has been said earlier namely that layers 11, 12 and 13 will receive water from the pond indirectly via layer 10.

There are numerous forms that the layers 10 and 12 may take and I will set forth two of those forms.

In one of said forms: (a) the strips 10 and 12 may be made of polypropylene cloth and have a thickness of 0.3 inches and a width of 30 inches; and (b) the filter strip 12 is made of high grade geotextile fabric which has a thickness of 0.3 inches and a width of 30 inches.

Another form that the layers 10 and 12 may take is described in the next four paragraphs.

Inlet layer 10 and outlet layer 12 may be made of permeable material that maintains the shape of said layers so that said layers appear empty. In one form of the invention, however, said layers comprise two separate plastic materials: two layers of a relatively rigid high density polyethylene (HDPE) drainage material that provides structure to said layers and an ethyl vinyl acetate (EVA) material that fills the space between said layers. In the current mode of that invention, said HDPE material is Poly-flex (a registered trademark). Drainage Net, and said interior filter material is Matala.™

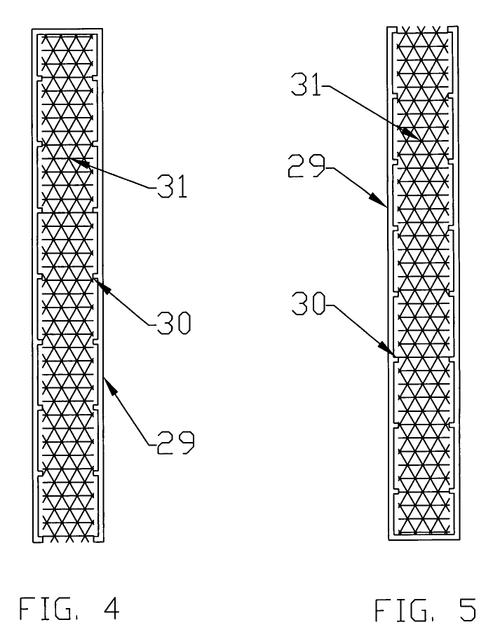

Poly-flex Drainage Net is a high-density polyethylene product between 0.25 and 0.50 inches thick, consisting of two sides. Each side has one series of ridges 31 (FIGS. 4 and 5) that run parallel to each other and are arranged at a 45 angle. Said ridges allow water to flow along said material, even when said material is placed directly against a solid surface. The material can be rolled into a spiral in only one direction at a time due to its design. When rolled, the grid develops limited rigidity perpendicular to the direction of the roll, thereby lending itself to creating a vertical spiral roll with structural integrity. This integrity also provides stability for the loose media rolled in the filter. In the present mode of this invention, inlet layer 10 and outlet layer 12 are each defined by two layers of Poly-flex Drainage Net.

Matala mat is placed between the two layers of Poly-flex Drainage Net that define inlet layer 10 and outlet layer 12. Matala is a proprietary material developed using the plastic EVA, which is extruded from nozzles to form spaghetti-like strands that adhere to one another. Said strands create a matrix with large amounts of open void space, through which water can flow freely. Because of the properties of EVA, Matala mats are both flexible and compressible, allowing them to be wrapped in a spiral between layers of Poly-flex Drainage Net. The mats used in one form of the invention may vary in thickness between ¾ of an inch and 1½ inches.

FIGS. 4 and 5 show cross sections of inlet layer 10 and outlet layer 12, respectively. In FIG. 4, inlet layer 10 is open at its bottom to allow water to flow into said layer. The sides of inlet layer 10 are defined by Poly-flex Drainage Net 29, which features drainage ridges 30. Matala mat 31 is placed within the open space defined by drainage net 29. In FIG. 5, outlet layer 12 is open at its top to allow water to flow upwards out of said layer. The sides of outlet layer 12 are again defined by Poly-flex Drainage Net 29, which features drainage ridges 30. Matala mat 31 is again placed within the open spaces defined by drainage net 29.

### Modified Form of the Invention

In one modified form of the invention, the outlet conduit of the cartridge 16 is elevated to a level above the cartridge and is open on top such that should the filter become occluded or there be a severe storm the pond will not overflow the top of the weir 21. This allows unfiltered water to flow directly into the treated water outlet conduit 18, to the outlet 22.

In another modified form of the invention the top and/or bottom of the cartridge are sealed and thereby limit how the water is able to enter the inlet layer 10.

A third form of the invention is one where the filter is operated in the reverse where the water enters in layers 12, is filtered through layers 11 and 13, and the outlet layer is 10.

A fourth form of the invention comprises keeping the diameter of pipe 17, 18 and 22 small enough to create a siphon effect that will tend to increase the rate of flow through the system.

I claim to have invented:

1. A filter for filtering a liquid comprising:
an inlet spiral layer that has an inner face, said spiral layer having an outer face exposed to the liquid to be filtered,
a spiral shaped filtering layer that has an outer face contiguous with said inner face, said filtering layer having an inner face,
a spiral shaped drainage layer having an outer face that is contiguous with the inner face of said filtering layer,
said drainage layer having an inner face,
a fourth spiral layer having an outer face contiguous with the inner face of said drainage layer, said fourth spiral layer receiving water to be filtered from said inlet layer and delivering filtered water to said drainage layer,
said fourth layer comprising filtering material, and
an outlet fed by said drainage layer.

2. A filter for filtering a liquid as defined in claim 1, in which said inlet layer has edges that are free to contact water to be filtered.

3. A filter for filtering a liquid as defined in claim 3, in which said filtering layer and said drainage layer all have edges, said edges having impermeable barriers on them to prevent entry of water.

4. A system for cleaning water comprising a plurality of contiguous layers wound around a center to form a spiral having a top side, a bottom side and a sidewall,
one of said layers being an input layer for receiving the water to be cleaned,
said input layer extending to and capable of receiving water from said top side, said bottom side and said sidewall.

5. A system for cleaning water as defined in claim 4, in which at least one of said layers is a filtering layer that receives the water to be cleaned from said input layer and cleans that water.

6. A system for cleaning water as defined in claim 4, in which said system has a vertical perforated outlet pipe that receives via said perforations filtered water that has been cleaned by said filtering layer.

7. A system for cleaning water as defined in claim 4, having two filtering layers one of which is contiguous with one of said sides of the inlet layer in which said input layer has two sides, with one of the filtering layers contiguous with one side of said input layer and the other of which filtering layers contiguous with the other side of said input layer.

8. A system for cleaning water as defined in claim 6, in which said spiral has an output layer that receives water from both of said filtering layers and a perforated output pipe forming the center of the spiral and receiving filtered water from said output layer through its perforations.

9. A system for cleaning water as defined in claim 6, in which said filtering layers extend from said top side to said bottom side and have impermeable barriers at said top and bottom sides to prevent a direct flow of water into said filtering layers from outside the system.

10. A system for cleaning water as defined in claim 4, in which a weir surrounds the filter in one plane.

11. A system for cleaning water as defined in claim 4, in which said layers are sheets of cloth.
